(19) United States
(12) Patent Application Publication
(10) Pub. No.: US 2003/0184520 A1
(43) Pub. Date: Oct. 2, 2003

(54) Mouse with optical buttons

(76) Inventor: Patrick Wei, Fort Collins, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/109,022

(22) Filed: Mar. 28, 2002

(51) Int. Cl. G09G 5/08

(52) U.S. Cl. 345/163

(57) ABSTRACT

A mouse device includes a motion detector for detecting motion of the mouse relative to a work surface. An optical mouse button optically detects movement of a finger positioned on the optical mouse button. A controller generates button press information based on the optically detected movement. The button press information indicates whether the optical mouse button has been actuated.

### REFERENCE TO RELATED PATENTS

This Application is related to the subject matter described in the following U.S. patents: U.S. Pat. No. 5,578,813, filed Mar. 2, 1995, issued Nov. 26, 1996, and entitled FREEHAND IMAGE SCANNING DEVICE WHICH COMPENSATES FOR NON-LINEAR MOVEMENT; U.S. Pat. No. 5,644,139, filed Aug. 14, 1996, issued Jul. 1, 1997, and entitled NAVIGATION TECHNIQUE FOR DETECTING MOVEMENT OF NAVIGATION SENSORS RELATIVE TO AN OBJECT; U.S. Pat. No. 5,786,804, filed Oct. 6, 1995, issued Jul. 28, 1998, and entitled METHOD AND SYSTEM FOR TRACKING ATTITUDE; U.S. Pat. No. 6,057,540, filed Apr. 30, 1998, issued May 2, 2000, and entitled MOUSELESS OPTICAL AND POSITION TRANSLATION TYPE SCREEN POINTER CONTROL FOR A COMPUTER SYSTEM; U.S. Pat. No. 6,151,015, filed Apr. 27, 1998, issued Nov. 21, 2000, and entitled PEN LIKE COMPUTER POINTING DEVICE; and U.S. Pat. No. 6,281,882, filed Mar. 30, 1998, issued Aug. 28, 2001, and entitled PROXIMITY DETECTOR FOR A SEEING EYE MOUSE.

### THE FIELD OF THE INVENTION

This invention relates generally to screen pointing devices. This invention relates more particularly to a mouse with optical buttons.

### BACKGROUND OF THE INVENTION

The use of a hand operated pointing device for use with a computer and its display has become almost universal. By far the most popular of the various devices is the conventional (mechanical) mouse, used in conjunction with a cooperating mouse pad. Centrally located within the bottom surface of the mouse is a hole through which a portion of the underside of a rubber-surfaced steel ball extends. Interior to the mouse are rollers, or wheels, that contact the ball at its equator and convert its rotation into electrical signals representing orthogonal components of mouse motion. These electrical signals are coupled to a computer, where software responds to the signals to change by a ΔX and a ΔY the displayed position of a pointer (cursor) in accordance with movement of the mouse.

In addition to mechanical types of pointing devices, such as a conventional mouse, optical pointing devices have also been developed. In one form of an optical pointing device, rather than using a moving mechanical element like a ball in a conventional mouse, movement between an imaging surface, such as a finger or a desktop, and photo detectors within the optical pointing device, is optically sensed and converted into movement information.

Existing optical and mechanical mouse devices use mechanical mouse buttons that require a user to apply a sufficient amount of downward pressure to overcome the mechanical resistance of the button and cause the button to be completely depressed. For such mechanical mouse buttons, the response time or the number of button presses per second that can be performed is limited by the mechanical characteristics of the buttons. In addition, repeated operation of such mechanical mouse buttons may cause a user to experience repetitive stress syndrome.

It would be desirable to provide a mouse with optical mouse buttons for faster response times, and without disadvantages of existing mechanical mouse buttons.

### SUMMARY OF THE INVENTION

One form of the present invention provides a mouse device including a motion detector for detecting motion of the mouse relative to a work surface. An optical mouse button optically detects movement of a finger positioned on the optical mouse button. A controller generates button press information based on the optically detected movement. The button press information indicates whether the optical mouse button has been actuated.

### BRIEF DESCRIPTION OF THE DRAWINGS

FIG. 1 is a top view of a prior art mouse.

FIG. 2 is a perspective view of a mouse with optical buttons according to one embodiment of the present invention.

FIG. 3 is an electrical block diagram illustrating major components of an optical motion sensor for implementing an optical mouse button according to one embodiment of the present invention.

### DESCRIPTION OF THE PREFERRED EMBODIMENTS

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

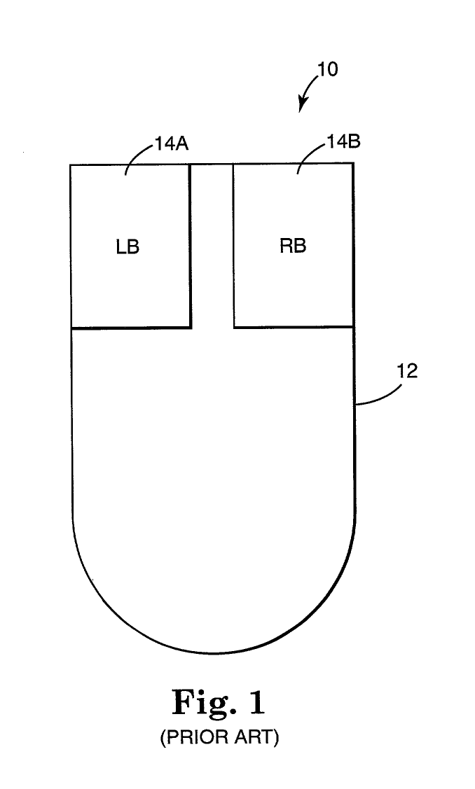

FIG. 1 is a top view of prior art mouse 10, which includes plastic case 12, left mouse button (LB) 14A, and right mouse button (RB) 14B. Mouse buttons 14A and 14B are conventional mechanical mouse buttons that require a user to apply a sufficient amount of downward pressure to overcome the mechanical resistance of the button and cause the button to be completely depressed. After one of buttons 14A or 14B is pressed and then released by a user, a mechanical mechanism returns the button to its original position. The mechanical nature of mouse buttons 14A and 14B limits how many times per second the buttons can be actuated.

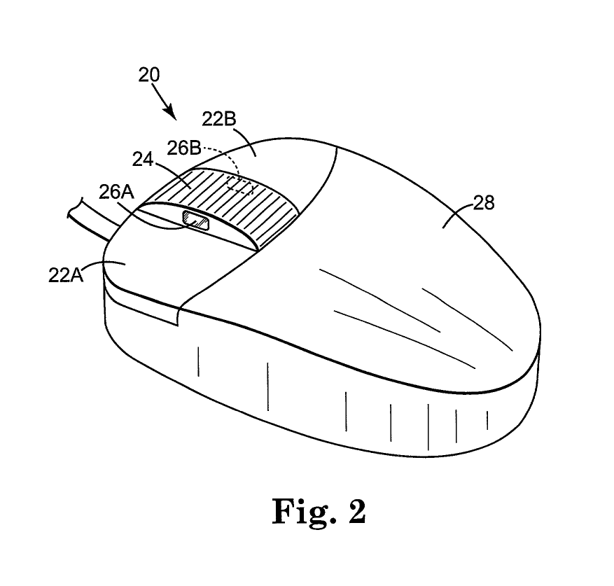

FIG. 2 is a perspective view of a mouse 20 with optical “buttons” according to one embodiment of the present invention. In one embodiment, mouse 20 is a mechanical mouse. In an alternative embodiment, mouse 20 is an optical mouse. Mouse 20 includes left button surface 22A, right button surface 22B, sensor housing 24, optical motion sensor 26A, optical motion sensor 26B, and plastic case 28. Optical motion sensor 26B is not visible in FIG. 2, and is therefore shown with dashed lines.

In operation, a finger is placed on surface 22A, and optical motion sensor 26A detects vertical movement (i.e., upward and downward movement) of the finger. In one embodiment, optical motion sensor 26A detects vertical movement of the finger by imaging the side of the finger, and detecting changes in positions of features of the finger in successive images as the finger is moved. If slight downward pressure is applied to surface 22A by the finger, optical motion sensor 26A detects the downward movement from the images of the finger, and a button press indication is generated when the magnitude of the downward movement exceeds a predetermined threshold amount. As the finger is lifted from surface 22A and less and less pressure is applied to surface 22A, optical motion sensor 26A detects the upward movement from the images of the finger, and a button release indication is generated when the magnitude of the upward movement is beyond a predetermined threshold amount.

Optical motion detector 26B operates in the same manner as described above for optical motion detector 26A, except that optical motion detector 26B detects movement of a finger positioned against surface 22B of mouse 20. Unique button press information is generated for each of optical motion detectors 26A and 26B to allow a computer or other device coupled to mouse 20 to identify which mouse “button” is being pressed.

Although the combination of surface 22A and optical motion detector 26A, and the combination of surface 22B and optical motion detector 26B, may each be referred to herein as an optical mouse “button,” in one embodiment, surfaces 26A and 26B do not move upward and downward like a conventional mechanical button. In an alternative embodiment, surfaces 26A and 26B are a soft, flexible surface, to allow a greater range of vertical movement of a finger. In another alternative embodiment, surfaces 26A and 26B are configured to move in a manner similar to a conventional mechanical mouse button, but have less mechanical resistance than conventional mechanical mouse buttons to provide faster response times and a decreased likelihood of repetitive stress problems for a user.

Although one embodiment of mouse 20 includes optical motion sensors 26A and 26B positioned adjacent and perpendicular to surfaces 22A and 22B, respectively, to image the side of a finger, in alternative embodiments, other positioning may be used for sensors 26A and 26B. For example, in one alternative embodiment, optical motions sensors 26A and 26B are placed parallel to and in the same plane as surfaces 22A and 22B, respectively, and a finger is placed directly on top of the motion detectors 26A and 26B. It will be understood by a person of ordinary skill in the art that more or less than two optical motion sensors 26A and 26B may be used for mouse 20, depending upon the number of mouse buttons needed for the particular implementation.

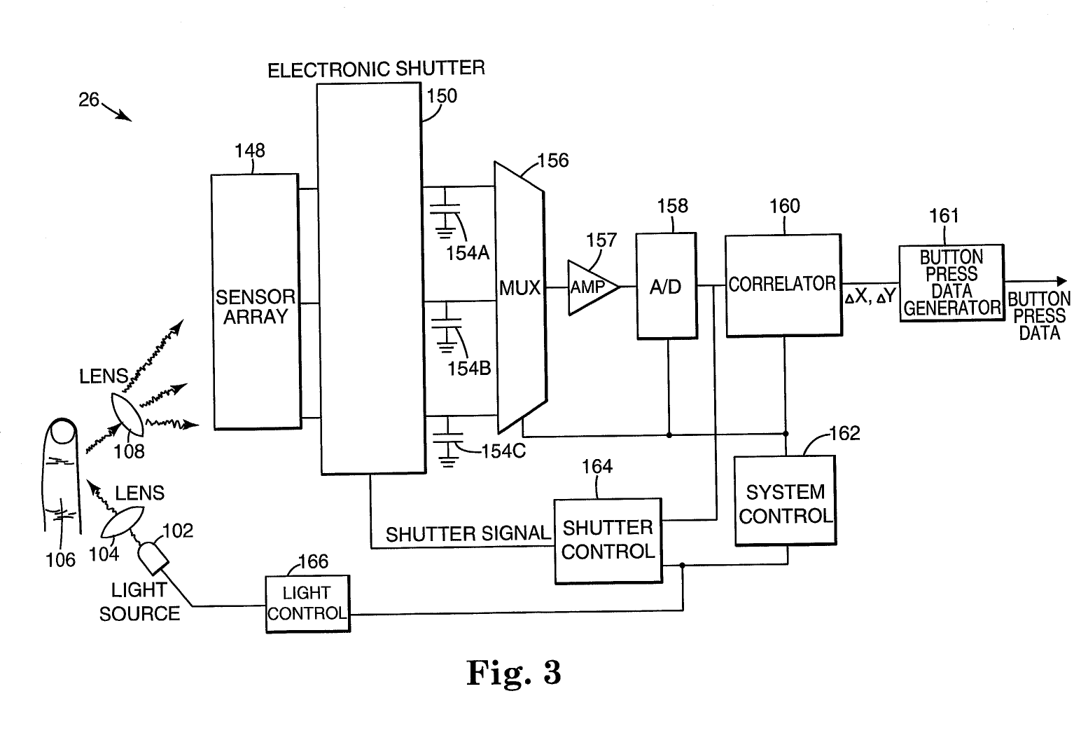

FIG. 3 is an electrical block diagram illustrating major components of an optical motion sensor 26 for implementing an optical mouse button according to one embodiment of the present invention. The optical motion sensor 26 shown in FIG. 3 represents one embodiment of a configuration for optical motion sensors 26A and 26B (shown in FIG. 2). Optical motion sensor 26 includes light source 102, lenses 104 and 108, photo detector array 148, electronic shutter 150, a plurality of sense capacitors 154A-154C (collectively referred to as sense capacitors 154), multiplexer 156, amplifier 157, analog to digital (A/D) converter 158, correlator 160, button press data generator 161, system controller 162, shutter controller 164, and light controller 166.

The operation of optical motion sensor 26 is primarily controlled by system controller 162, which is coupled to multiplexer 156, A/D converter 158, correlator 160, shutter controller 164, and light controller 166. In operation, according to one embodiment, light source 102 emits light that is projected by lens 104 onto finger 106. Light source 102 is controlled by signals from light controller 166. Reflected light from finger 106 is directed by lens 108 onto photo detector array 148. Each photo detector in photo detector array 148 provides a current that varies in magnitude based upon the intensity of light incident on the photo detector.

Electronic shutter 150 is controlled by a shutter signal from shutter controller 164. When electronic shutter 150 is “open,” charge accumulates on sense capacitors 154, creating a voltage that is related to the intensity of light incident on the photo detectors in array 148. When electronic shutter 150 is “closed,” no further charge accumulates or is lost from sense capacitors 154. Multiplexer 156 connects each sense capacitor 154 in turn to amplifier 157 and A/D converter 158, to amplify and convert the voltage from each sense capacitor 154 to a digital value. Sense capacitors 154 are then discharged through electronic shutter 150 so that the charging process can be repeated.

Based on the level of voltage from sense capacitors 154, A/D converter 158 generates a digital value of a suitable resolution (e.g., one to eight bits) indicative of the level of voltage. The digital values for the photo detector array 148 represent a digital image or digital representation of a portion of finger 106. The digital values are stored as a frame into corresponding locations within an array of memory within correlator 160.

The overall size of photo detector array 148 is preferably large enough to receive an image having several features (e.g., whorls of skin in a finger). Images of such spatial features produce translated patterns of pixel information as finger 106 is moved up and down relative to surface 22A or 22B. The number of photo detectors in array 148 and the frame rate at which their contents are captured and digitized cooperate to influence how fast finger 106 can be moved and still be tracked. Tracking is accomplished by correlator 160 by comparing a newly captured sample frame with a previously captured reference frame to ascertain the direction and amount of movement. In one form of the invention, motion tracking is accomplished using techniques disclosed in the related patents identified above in the Reference to Related Patents section, and summarized below.

In one embodiment, the entire content of one of the frames is shifted by correlator 160 by a distance of one pixel successively in each of the eight directions allowed by a one pixel offset trial shift (one over, one over and one down, one down, one up, one up and one over, one over in the other direction, etc.). That adds up to eight trials. Also, since there might not have been any motion, a ninth trial “null shift” is also used. After each trial shift, those portions of the frames that overlap each other are subtracted by correlator 160 on a pixel by pixel basis, and the resulting differences are preferably squared and then summed to form a measure of similarity (correlation) within that region of overlap. Larger trial shifts are possible, of course (e.g., two over and one down), but at some point the attendant complexity ruins the advantage, and it is preferable to simply have a sufficiently high frame rate with small trial shifts. The trial shift with the least difference (greatest correlation) can be taken as an indication of the motion between the two frames. That is, it provides raw movement information that may be scaled and/or accumulated to provide movement information (ΔX and ΔY) of a convenient granularity and at a suitable rate of information exchange. Since, in one embodiment, finger 106 will be primarily moved in only one dimension (i.e., up and down), there will be little change in the movement information for one dimension (e.g., ΔX), and much greater change in the movement information for the second dimension (e.g., ΔY).

The movement information output by correlator 160 is processed by button press data generator 161. Button press data generator 161 analyzes the magnitude and direction of movement of the finger 106, and generates and outputs appropriate button press data. If finger 106 is moved downward beyond a threshold amount, button press data generator 161 generates and outputs a button press indication. After being moved downward, if finger 106 is then moved upward beyond a threshold amount, button press data generator 161 generates and outputs a button release indication.

In addition to providing digital images to correlator 160, A/D converter 158 also outputs digital image data to shutter controller 164. Shutter controller 164 helps to ensure that successive images have a similar exposure, and helps to prevent the digital values from becoming saturated to one value. Controller 164 checks the values of digital image data and determines whether there are too many minimum values or too many maximum values. If there are too many minimum values, controller 164 increases the charge accumulation time of electronic shutter 150. If there are too many maximum values, controller 164 decreases the charge accumulation time of electronic shutter 150.

In one form of the invention, in addition to providing mouse button functionality, one or both of optical motion detectors 26A or 26B also act as a fingerprint sensor to authenticate the user of mouse 20. To provide fingerprint recognition functionality, optical motion detectors 26A and 26B operate as described above to capture an image of a user's finger, and correlator 160 then correlates the captured image with a previously captured image of a finger, and determines whether the images match. Techniques for comparing fingerprint images and identifying matching fingerprint images are known to those of ordinary skill in the art. In one embodiment, before mouse 20 can be operated in a normal manner, a user's identity must be authenticated by having the user's fingerprint verified using one of optical motion detectors 26A or 26B.

Embodiments of the present invention provide numerous advantages over conventional mechanical mouse buttons. One embodiment provides faster response times than conventional mechanical mouse buttons. In one form of the invention, the response time of the optical mouse buttons is programmable to provide optimal response characteristics for each type of software application. For example, for office software, the button response can be programmed to be slower, and for game software, the button response can be programmed to be faster. Embodiments of the present invention provide an ergonomic improvement over conventional mechanical mouse buttons. In one form of the invention, the pressure sensitivity of the optical mouse buttons can be adjusted without affecting the actuation sensitivity of the buttons. In addition, in one embodiment, the optical mouse buttons provide fingerprint sensor functionality.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A mouse device comprising:
a motion detector for detecting motion of the mouse relative to a work surface;
an optical mouse button for optically detecting movement of a finger positioned on the optical mouse button; and
a controller for generating button press information based on the optically detected movement, the button press information indicating whether the optical mouse button has been actuated.

2. The mouse device of claim 1, wherein the optical mouse button optically detects movement of the finger by correlating successive digital images of the finger to determine a direction and an amount of movement.

3. The mouse device of claim 1, wherein the optical mouse button includes a first surface for placement of a finger, and an optical motion detector for detecting movement of finger placed on the first surface.

4. The mouse device of claim 3, wherein the optical motion detector is positioned adjacent and perpendicular to the first surface.

5. The mouse device of claim 3, wherein the optical motion detector is positioned parallel to and in the same plane as the first surface.

6. The mouse device of claim 1, wherein the mouse device is a mechanical mouse.

7. The mouse device of claim 1, wherein the mouse device is an optical mouse.

8. The mouse device of claim 1, wherein the optical mouse button and the controller are configured to act as a fingerprint recognition sensor.

9. A method for generating data for controlling a screen pointer with a mouse, the method comprising:
sensing motion of the mouse relative to a work surface;
generating a first set of movement data based on the sensed motion of the mouse, the first set of movement data indicative of motion of the mouse relative to the work surface;
optically sensing motion of a finger placed on the mouse;
generating a second set of movement data based on the optically sensed motion of the finger, the second set of movement data indicative of motion of the finger; and
generating button press information based on the second set of movement data.

10. The method of claim 9, wherein the step of optically sensing motion of a finger comprises:
correlating successive digital images of the finger to determine a direction and an amount of movement of the finger.

11. The method of claim 9, wherein the mouse is a mechanical mouse.

12. The method of claim 9, wherein the mouse is an optical mouse.

13. The method of claim 9, wherein motion of the finger is optically sensed with an optical motion sensor, the method further comprising:
capturing an image of the finger with the optical motion sensor;
comparing the captured image of the finger with stored image data; and
determining whether the captured image of the finger matches a stored image.

14. The method of claim 13, and further comprising:
controlling operation of the mouse based on the determination of whether the captured image of the finger matches the stored image.

15. A mouse device for generating data for controlling a screen pointer, the mouse device comprising:
a motion detection mechanism for detecting movement of the mouse device relative to a work surface;
a first surface on the mouse device for placement of a finger;
an optical motion detector for generating movement data representative of movement of a finger placed on the first surface; and
a controller for generating button press data based on the generated movement data.

16. The mouse device of claim 15, wherein the optical motion detector generates movement data by correlating successive digital images of the finger to determine a direction and an amount of movement.

17. The mouse device of claim 15, wherein the optical motion detector is positioned adjacent and perpendicular to the first surface.

18. The mouse device of claim 15, wherein the optical motion detector is positioned parallel to and in the same plane as the first surface.

19. The mouse device of claim 15, wherein the mouse device is a mechanical mouse.

20. The mouse device of claim 15, wherein the mouse device is an optical mouse.

21. The mouse device of claim 15, wherein the optical motion detector and the controller are configured to act as a fingerprint recognition sensor.
